(19) United States
(12) Patent Application Publication
(10) Pub. No.: US 2019/0094643 A1
(43) Pub. Date: Mar. 28, 2019

(54) METAL ACCRETION BUS BARS

(71) Applicant: View, Inc., Milpitas, CA (US)

(72) Inventors: Robin Friedman, Sunnyvale, CA (US); Brian D. Griedel, El Cerrito, CA (US)

(21) Appl. No.: 16/081,867

(22) PCT Filed: Mar. 8, 2017
(86) PCT No.: PCT/US2017/021408

§ 371 Date: Aug. 31, 2018

Related U.S. Application Data
(60) Provisional application No. 62/428,999, filed on Dec. 1, 2016.
(60) Provisional application No. 62/305,946, filed on Mar. 9, 2016.

(51) Int. Cl. G02F 1/1514; C23C 24/04; C23C 4/08; E06B 9/24; E06B 3/67; G02F 1/155

(52) U.S. Cl. CPC G02F 1/1514; C23C 24/04; C23C 4/08; E06B 2009/2464; E06B 3/6722; G02F 1/155; E06B 9/24

(57) ABSTRACT

Electrochromic devices such as electrochromic windows may employ accretively deposited bus bars. Forming bus bars by accretive deposition rather than by conductive inks can reduce fabrication time and costs. Accretive deposition processes may be implemented with high throughput to create highly conductive pure metal and/or alloy features that have good surface adhesion to a substrate such as glass or a transparent conducting layer. Accretive deposition may be used to mechanically and/or electrically bond a wire to a bus bar. In some processes, deposition is primarily ballistic, and particles ejected from a nozzle are deposited by mechanical or metallurgical bonding upon impact. In some cases, particles are heated via a gas or plasma before impacting a substrate.

### PRIORITY CLAIMS

This application claims benefit of U.S. Provisional Patent Application No. 62/305,946, filed Mar. 9, 2016, and titled “COLD SPRAY BUS BARS,” and U.S. Provisional Patent Application No. 62/428,999, filed Dec. 1, 2016, and titled, “METAL ACCRETION BUS BARS,” which are both incorporated herein by reference in their entireties and for all purposes.

### FIELD

The embodiments disclosed herein relate generally to thin film deposition techniques in which material accretes to form bus bars, conductive lines, circuitry and other similar features within an electrochromic (EC) structure such as an electrochromic window, which may be provided in an insulated glass unit (IGU).

### BACKGROUND

Electrochromism is a phenomenon in which a material exhibits a reversible electrochemically-mediated change in an optical property when placed in a different electronic state, typically by being subjected to a voltage change. The optical property is typically one or more of color, transmittance, absorbance, and reflectance. One widely-used electrochromic material is tungsten oxide. Tungsten oxide is a cathodic electrochromic material in which a tint transition, transparent to dark blue, occurs by electrochemical reduction.

Devices made from electrochromic materials may be incorporated into, for example, windows or mirrors for home, vehicle, commercial and other uses. The color, transmittance, absorbance, and/or reflectance of such devices may be changed by inducing an electrical change in the electrochromic material. In one application, an electrochromic window is darkened by applying a defined electric potential across an electrochromic device; reversing the voltage polarity causes the device to lighten. This capability allows control of the amount of light, and hence radiant energy, passing through a window and presents an opportunity for electrochromic windows to be used as energy-saving devices.

Many electrochromic devices include bus bars to apply an electrical potential across an electrochromic device. As such, bus bars are conductive structures that are used for an electrical interface between transparent conducting layers (TCLs) of electrochromic devices and external wiring that connects to a window controller. Generally, bus bars may be substantially more conductive than the materials that make up transparent conducting layers such as indium tin oxide (ITO), fluorinated tin oxide (FTO) and similar coatings that are used for the transparent conducting layers of the electrochromic device. Bus bars are commonly configured to reduce an ohmic potential drop that might otherwise occur across a transparent conducting layer. For example, for large electrochromic devices such those applied to large windows, bus bars may span all or nearly the full length of the device in contact with a transparent conducting layer in one or more directions. By applying a potential across the entire length of a large device (as opposed to merely applying a potential to a point), the bus bars improve switching uniformity and increase the speed of transition between optical states.

Electrochromic devices have an electrochromic stack between two transparent conducting layers (TCLs). Complimentary coloring EC stacks typically have three layers: an electrochromic layer that is cathodically tinting and anodically clearing, an intermediate layer that is electrically insulating but allows passage of ions, and a second electrochromic layer that is anodically tinting and cathodically clearing. One of the transparent conducting layers is attached to a glass substrate but often separated by a diffusion barrier that prevents a flux of ions (e.g., sodium ions) into or out of the substrate, e.g. soda lime glass is often used as a substrate and contains sodium ions which would otherwise poison the device.

The transparent conducting layers may be made of a metal oxide or other suitable material, that is, among other things, conductive and transparent. Transparent conductive oxides include metal oxides and metal oxides doped with one or more metals. Examples of suitable metal oxides and doped metal oxides include indium oxide, indium tin oxide, doped indium oxides, tin oxide, doped tin oxides, zinc oxide, aluminum zinc oxide, doped zinc oxides, ruthenium oxide, doped ruthenium oxides, and the like. Fluorinated tin oxides may also be used. TCLs may also be thin layers of metal that are substantially transparent. The TCL should have an appropriate sheet resistance (Rs) because of the relatively large area these layers may span. In some embodiments, the sheet resistance of transparent conducting layers is between about 5 and about 30 Ohms per square. In some embodiments, the sheet resistance of transparent conducting layers is about 15 Ohms per square. In general, it is desirable that the sheet resistance of each of the two conductive layers be about the same.

### SUMMARY

One aspect of the present disclosure pertains to a method of forming a bus bar for an electrochromic device that includes (a) receiving a substrate having at least one transparent conductive layer of an electrochromic device, and (b) accretively depositing a bus bar on at least a portion of the substrate or transparent conducting layer.

In some embodiments, accretively depositing the bus bar includes depositing particles of a material comprising the bus bar by a mechanism that is primarily ballistic. For example, depositing particles of the material may include driving the particles from an accretive deposition apparatus containing a nozzle that produces a gas jet that drives particles at high velocity towards the substrate. In some cases, particles leaving the nozzle have a mean particle velocity of between about 500 and 1500 m/s.

In some embodiments, particles may have an average diameter of between about 10 μm and 100 μm. In some embodiments, particles may include copper, aluminum, and/or silver.

In some embodiments, a first set of first particles and a second set of second particles may be deposited, where the particles of the first and second sets have different optical properties. In some embodiments, the optical properties of the second particles at least partially mask or obscure visual perception of the bus bar. In some embodiments, the set of first particles is deposited to partially coat the at least a portion of the substrate or transparent conducting layer. In some embodiments, the second particles include a metal or alloy, and the second particles coat regions of the at least a portion of the substrate or transparent conducting layer that are not coated by the first particles. In some embodiments, the first particles are tungsten and the second particles are copper.

In some embodiments, the electrochromic device is disposed between the transparent conducting layer and a second transparent conducting layer. In some embodiments, the bus bar is a material that has a resistivity of 10 uΩ/cm or less.

In some embodiments, accretively depositing the bus bar means depositing metal or alloy particles with only enough velocity to partially deform on the substrate or transparent conductive layer.

In some embodiments, an external wire is placed at a location of the bus bar and bonding and bonded to the bus bar via accretive deposition. The external wire may be connected to a window controller. In some cases, an external wire includes a flattened region, a tab, or a splayed region on the bus bar.

In some embodiments the method forming a bus bar for an electrochromic device further includes depositing a first layer at the location of the bus bar on the transparent conductive layer or the substrate, placing an external wire on the first layer, and depositing a second layer over the external wire, where depositing the second layer includes the accretive deposition operation. In some cases, the first layer includes aluminum and the second layer includes copper or silver.

In some embodiments, accretive deposition includes ejecting particles of the bus bar material through a DeLaval nozzle. In some cases, accretive deposition of the bus bar includes cold spraying particles of the bus bar material. In some cases, a vacuum is applied to remove particles that do not form the bus bar.

In some cases, accretively depositing the bus bar includes exposing metal or alloy particles to a plasma before they contact the substrate or transparent conductive layer.

In some cases, a microplasma is applied the substrate or transparent conductive layer before accretively depositing the bus bar.

Another aspect of the disclosure pertains to an apparatus that includes an accretive deposition structure having a nozzle that is configured to accretively deposit particles to form a bus bar on a substrate with at least one transparent conductive layer of an electrochromic device disposed thereon.

In some cases, the accretive deposition structure is a high-pressure or low-pressure cold spray apparatus, and in some cases, the accretive deposition structure is a hot spray apparatus.

In some cases, the accretive deposition structure has a deposition efficiency that is greater than 95%.

In some cases, an apparatus also includes a vacuum system configured to remove deposited particles. For example, an apparatus may have an outer jacket, concentric with the nozzle, where a region between the nozzle and the outer jacket is configured to provide a localized vacuum area. In some cases, the outer jacket contains perforations and/or a mesh to allow an inward flow of air. In some cases, the outer jacket is made from a Teflon material, is spring loaded, or has a brush tip.

In some cases, an apparatus includes an apertured or channeled block configured to travel with the nozzle to prevent particulate contamination beyond the bus bar. In some cases, an apparatus includes a structure configured to provide a jet of gas to blow particles off the substrate and/or transparent conductive layer.

In some cases, the accretive deposition structure is a plasma spray apparatus. In some cases, the plasma spray apparatus is configured to operate at atmospheric pressure.

A plasma spray apparatus may include a first electrode that forms a nozzle through which plasma exits, a second electrode positioned at an interior location to the first electrode, and a voltage supply that is configured to apply an electric potential between the first electrode and the second electrode. In some cases, the plasma spray apparatus has a powder feedstock pathway configured to introduce the powder feedstock into plasma exiting the nozzle. In some cases, a plotter moves the plasma spray apparatus in the X-Y plane. In some cases, the apparatus is configured to deposit particles from the powder feedstock at subsonic velocities.

### BRIEF DESCRIPTION OF FIGURES

FIG. 1 depicts a conventional electrochromic insulated glass unit.

FIGS. 2A-E depict various methods in which materials may be accretively deposited.

FIG. 3 depicts a splayed wire end and a fastener tab that may be used to improve mechanical and or electrical bonding of a wire to bus bar.

FIG. 4 depicts various shapes that may be used for fastener tabs.

FIG. 5 depicts a method in which accretive deposition is used to bond a fastener tab to a substrate.

FIG. 6A and 6B depict a method in which accretive deposition is used to bond a fastener tab to a substrate.

FIG. 7A and 7B depict embodiments of a cold spray apparatus.

FIG. 8A-E depict various apparatus that may be used to facilitate removal of undeposited particles from the target substrate.

FIG. 9 is a process flow of a method for fabricating an optical device (e.g., an electrochromic device) having opposing bus bars, each applied to one of the conductor layers of the optical device.

FIG. 10 depicts a cross-sectional view of an APS apparatus.

### DESCRIPTION

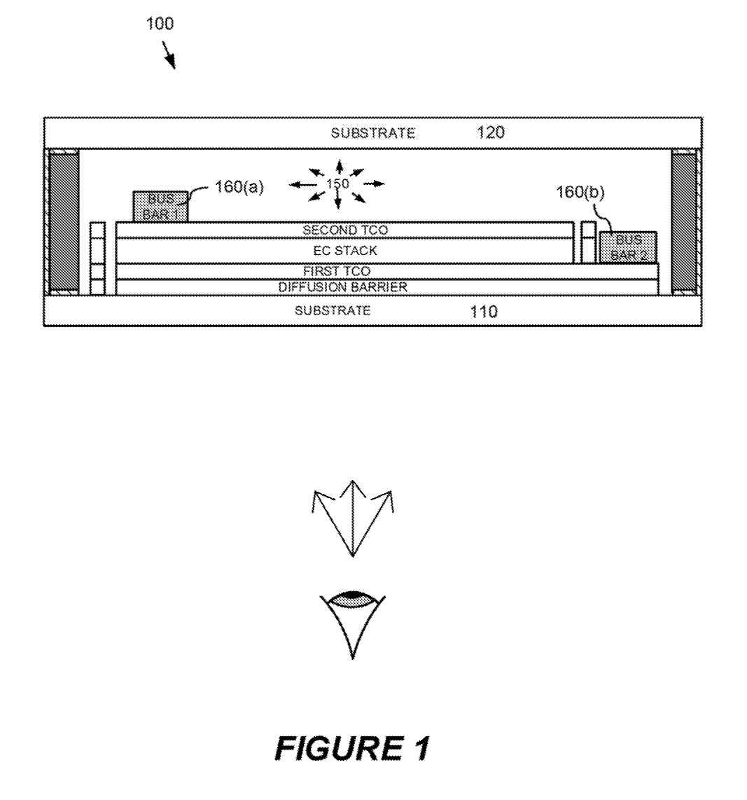

FIG. 1 shows a conventional electrochromic IGU, 100, and an observer (as depicted with the stylized eye) viewing the IGU. In some IGU designs, the observer might be able to view both bus bars and other features when the EC coating is in the tinted and/or clear state. In a conventional configuration, there are two bus bars 160(a) and 160(b) that are attached to the two transparent conductive layers on either side of the electrochromic (EC) stack.

Conventional bus bars are made from conductive inks that typically include conductive particles suspended in a solvent solution containing polymer, which may be dissolved in the solvent. Common conductive particles used in such inks include silver, copper, gold, and various metal alloys and conductive polymers. A bus bar is fabricated on an electrochromic device by applying conductive ink onto a transparent conducting layer and evaporating the solvent from the ink by heating. When the solvent evaporates, the conductive particles densify and eventually harden, sometimes enmeshed in a matrix contained in the ink. Aggregate particles may be immobilized by a binding agent such as a polymer in the ink solution so that sufficient particles are touching to make a conductive network of particles in the body of the bus bar.

While bus bars fabricated from inks adequately meet the needs of many electrochromic device applications, it would be desirable to have alternatives that provide fast, easy, and inexpensive integration into the manufacturing flow of electrochromic devices. This disclosure presents methods that may be used as an alternative to ink based disposition techniques for fabricating bus bars on electrochromic devices. These newly applied processes may be characterized as accretive deposition processes. As described herein, such processes may be implemented with high throughput to create highly conductive features such as bus bars. In various embodiments, the accretive processes deposit pure metal and/or alloys without the need for solvent, polymeric binders, and painting or evaporative fabrication techniques. The resulting structures typically have good surface adhesion to a substrate such as a window glass or a transparent conducting layer. In certain embodiments, the accretive deposition process may be used deposit features having a coefficient of thermal expansion that matches the substrate.

### I. Accretive Deposition Methods

Accretive based deposition, as disclosed herein, is a mechanical (or primarily mechanical) process in which small particles are accelerated by a gas jet and driven onto a substrate at a high velocity such that they impact, plastically deform, and coalesce on the substrate to form a layer of material. Movement of the jet of particles in relation to the substrate may be controlled, allowing for carefully patterned layers to be formed on a substrate. Accretively deposited layers may be patterned selectively without the need to selectively mask areas or later remove material as is common in widely-used physical and chemical deposition processes such as sputtering and thermal evaporation.

Accretion based deposition proceeds by a mechanism that is primarily ballistic. Particles are shot out of a jet or nozzle at the substrate and are added to the substrate material by mechanical or metallurgical bonding upon impact. The bonding energy and accumulation of the deposited layer is primarily a result of kinetic energy that is transferred to material deformation and heat upon particle impact. As particles fuse together, it is possible to create incredibly dense, pure and adherent material coatings on the surface of a substrate with uniform material properties. In some embodiments, this process is not primarily a plasma mediated process or a chemically mediated process; rather it is mainly material accretion as a result of the kinetic energy a particle has before impacting the substrate and/or already accreted material. In some embodiments particles deform partially, retaining part of their original shape. As an example, particles may deform to a thickness of about half of their diameter prior to impact. The deformation of particles may vary significantly between embodiments as deformation is highly dependent on material properties and deposition parameters.

For particles to achieve sufficient kinetic energy to bond on impact, they must travel at high speed. In various embodiments, the particles have a primarily spherical shape. In embodiments where particles are non-spherical, such as rod-shaped particles, the diameter values (and any other geometry based values) refer to the largest dimension unless otherwise specified. In some embodiments, the ejected particle diameter is between about 50 nm and about 200 μm; in other embodiments, between about 1 μm and 200 μm; and in still other embodiments, between about 10 μm and about 100 μm. The appropriate particle diameter for accretive deposition may depend upon the particle material, the substrate material, the gas temperature, gas pressure, and other parameters of the deposition process and/or apparatus. Those skilled in the art would appreciate that deposition parameters may need to be optimized to ensure proper adhesion, material properties and to prevent damage to the underlying device layer(s).

While there is a wide range of particle sizes that may be used, the distribution in the size of particles may be somewhat tight. In some embodiments the variance in particle diameter is less than about 20% of the mean diameter; in other embodiments less than about 10% of the mean diameter; and in still other embodiments less than about 5% of the mean diameter.

In some embodiments, particles are ejected from a nozzle at supersonic velocities. In some embodiments, particles are ejected at sonic or subsonic velocities. The exit velocity may vary based upon particle properties, deposition parameters, and desired properties of the deposited material. Ultimately, the kinetic energy imparted to the particles determines how they impact, deform, adhere and accrete. In some implementations, particles are ejected at a mean velocity of between about 500 m/s and 1500 m/s. In some implementations, particles are ejected at a mean velocity of about 1000 m/s, and in other implementations about 600 m/s.

One example of a suitable accretive deposition method is termed “cold spray.” In a cold spray process, particle and gas temperatures in the jet are below the melting point of the material being deposited. The cold spray process may be advantageously used in applications where the deposition materials have higher melting temperatures than materials found elsewhere on the substrate. The cold spray apparatus and process are further discussed herein. Cold spraying technology is further described in U.S. Pat. No. 5,302,414, which is incorporated herein by reference in its entirety.

Another example of a suitable accretive deposition process is “hot spraying.” In this embodiment, particle and gas temperatures in the jet are above the melting point of the deposited material. Due to an increase in thermal energy, less kinetic energy is needed allowing for slower particle velocities and potentially less ballistic damage.

### II. Accretively Deposited Bus Bars

Accretively deposited bus bar materials may include a variety of solid materials including metals, alloys, metal oxides, and/or carbon based materials. While conductive materials may be needed for bus bar applications, insulating materials may be used to help prevent short-circuiting an electrochromic device or improve the optical properties of an electrochromic device. Thus, when used herein, the concept of a bus bar includes not only the primary conductive structure (used to apply a defined electrical potential to an attached TCL) but also any associated material used for a purpose that is not directly related to applying a potential. In some cases, an associated material may be used for obscuring or rendering the bus bar less noticeable to an observer, facilitating adhesion to the TCL or other portion of the substrate, or matching the bus bar and substrate coefficients of thermal expansion. In some cases, an associated material may be used to passivate a bus bar and protect against oxidation, thermal degradation, UV degradation, and other problems created by exposure to the ambient or IGU environments.

Metals that may be deposited by accretive deposition to form bus bars include, but are not limited to, gold, copper, aluminum, and silver. Alloys that may be deposited by accretive deposition include e.g. alloys of any of the aforementioned metals with e.g. nickel, tungsten, iron, lead, zinc, iridium, platinum, molybdenum, palladium, tin, titanium and/or chromium. Metal mixtures (and intermetallics) may also be used, e.g. copper and silver, copper and gold or copper and tungsten. When metals or metal alloys are deposited via cold spray, deposited film structures may be dense with low oxygen content and substantially free of residual tensile stress, grain growth, recrystallization zones, and phase changes. Certain metals may even experience grain refinement at the nanometer scale in which the grains of the deposited material are smaller than the grains of the particles before deposition. Metals and alloys may be deposited in pure or nearly pure elemental composition (or at the alloy composition) being largely devoid of oxygen or metal oxide content and requiring no filler or polymeric binders. Depositing metals with these characteristics may yield good quality bus bars meeting stringent mechanical and electrical criteria.

In some embodiments, the bus bar material includes or is aluminum. Aluminum, in part due to its low density, has a lower impact energy than other metals such as copper or silver and thus may be used to prevent damage to layers of the electrochromic device (e.g., the TCL on which the bus bar is deposited) while still being suitably conductive. In other embodiments, metals such as copper, silver, or gold may be used because of their superior conductive properties. Cold spray aluminum may also exhibit excellent adhesion to a variety of surface morphologies and materials and may be used alone as a bus bar material or as an adhesion layer for other metals such as copper, silver, and gold, e.g. in a two-layer format.

Alloys particles may be deposited in the same manner as metal particles, provided that particles are already in alloy form prior to being ejected from a nozzle. In some cases, mixtures of metals may be deposited as conglomerates, e.g., provided differences in density and/or particle weight are sufficiently small. For example, copper and silver particles (or copper and tungsten particles) have similar densities and may be deposited concurrently.

In various embodiments, accretively deposited materials used to form a bus bar or in conjunction with a bus bar are deposited in multiple layers to form a laminate structure. Various materials may be deposited in layers to form engineered laminates. For example, a first material is deposited as an adhesion layer, that exhibits high adhesion to the substrate, followed by a second layer that is deposited for its superior electrical properties (e.g., higher conductivity than the underlying layer) but has less adhesiveness to the substrate. One example would be aluminum as the adhesion layer and copper or silver as the overcoat layer. In another example, a first material may be deposited with relatively little damage to the substrate during accretive deposition, while a second material, deposited over the first material, would more likely damage the substrate if deposited first. Again, as an example, aluminum is very light and may not damage the TCL or device layers during accretion. In yet another example, a first deposited material may have a coefficient of thermal explanation between that of the underlying substrate and a principal conductive layer deposited on the first material. In certain embodiments, an aluminum adhesion layer is deposited followed by a copper conducting layer. In another embodiment, an aluminum adhesion layer is deposited followed by a silver conducting layer. In laminates including an aluminum adhesion layer, aluminum may protect or shield layers of the electrochromic device from the higher impact energies of subsequently deposited copper or silver particles. In these embodiments, copper or silver may be used to provide the bus bar with higher electrical conductivity and potentially better wire bonding, as described elsewhere herein.

The width of bus bars may vary based on factors such as the thickness and location of the bus bar on the substrate, the conductivity of the bus bar material, and/or the size of the IGU. In some embodiments, the average width of a bus bar is less than 10 mm. In some cases, the average width is less than about 5 mm, less than about 3 mm, less than about 2 mm, or less than about 1 mm.

The thickness of bus bars may vary depending on factors such as the width of the bus bar, the conductivity of the bus bar material(s), the location of the bus bar on a window, and/or the size of the IGU. In some embodiments, the thickness of bus bars widens or narrows over its length. For example, the thickness of a bus bar may vary to provide a more even electrical potential to the transparent conducting layer. In some cases, the thickness of a bus bar may vary to traverse a sealing area; e.g., the bus bar may be thinner in regions sealed between the glass substrate and a spacer of an insulated glass unit (IGU). As another example, a bus bar may be accretively deposited to a greater thickness at distal regions when the external wiring attaches to a central portion of the bus bar. Additionally, the thickness of the bus bar may increase to accommodate bonding an external wire lead to the bus bar. In certain embodiments, the average thickness of the bus bar is about 1 millimeter or thinner, e.g., about 0.5 millimeters or thinner, or about 0.2 millimeters or thinner. In some implementations, the average thickness of a bus bar is about 50 μm, in other embodiments the thickness is about 100 μm, in other embodiments the thickness is about 50 μm.

In some implementations, the resistivity of deposited bus bar material using this deposition method is less than 20 uΩ/cm or less than about 10 uΩ/cm. When using accretively deposited pure silver, the resistivity may approach values close to that of bulk silver at 1.6 uΩ/cm. Low bulk resistance in bus bars is advantageous as it allows for quicker and more uniform window tint transitions. Metals with low intrinsic resistivity may provide suitably low bulk resistivity, even when an accretively deposited bus bar has a relatively small width and/or thickness.

Bus bars fabricated from a metallic material usually have a prominent metallic reflectivity and color such as silver or copper that can be visually unappealing in certain applications, such as butt joints, where the bus bar is visible to the end user. Examples of bus bar concealment techniques can be found in PCT Patent Application having Publication No. 2015100419, filed Dec. 24, 2014, which is incorporated herein by reference in its entirety. In certain implementations, the bus bar does not exhibit significant specular reflection from a surface facing the direction where an occupant would view the electrochromic device, typically the underside of the bus bar.

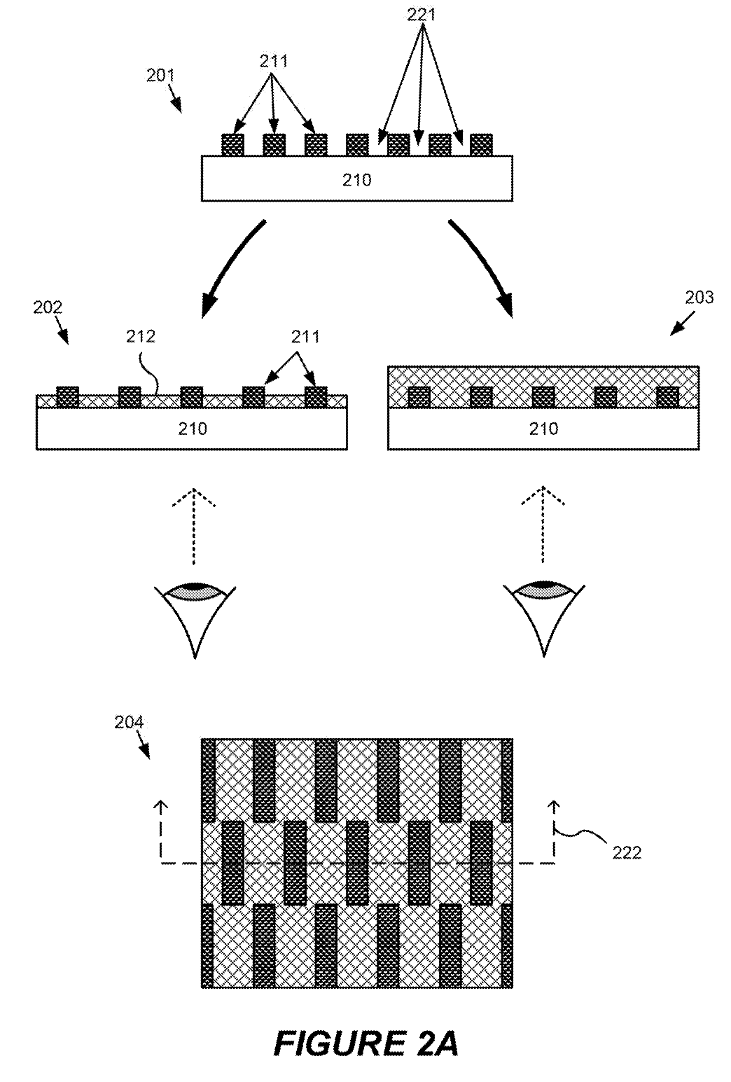

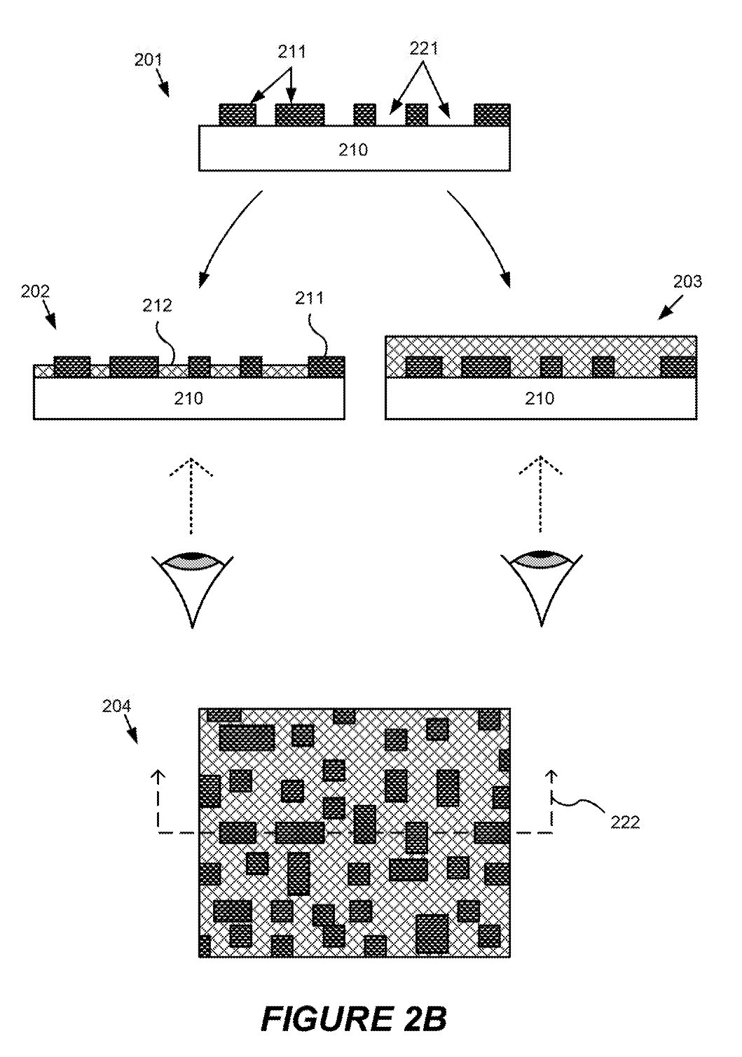

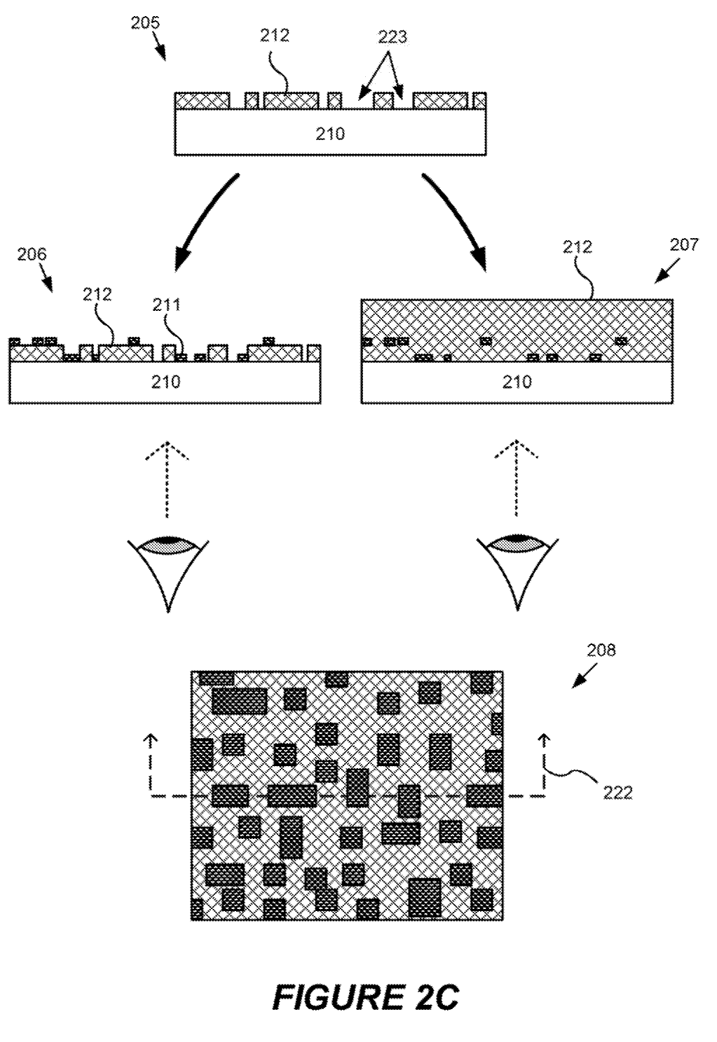

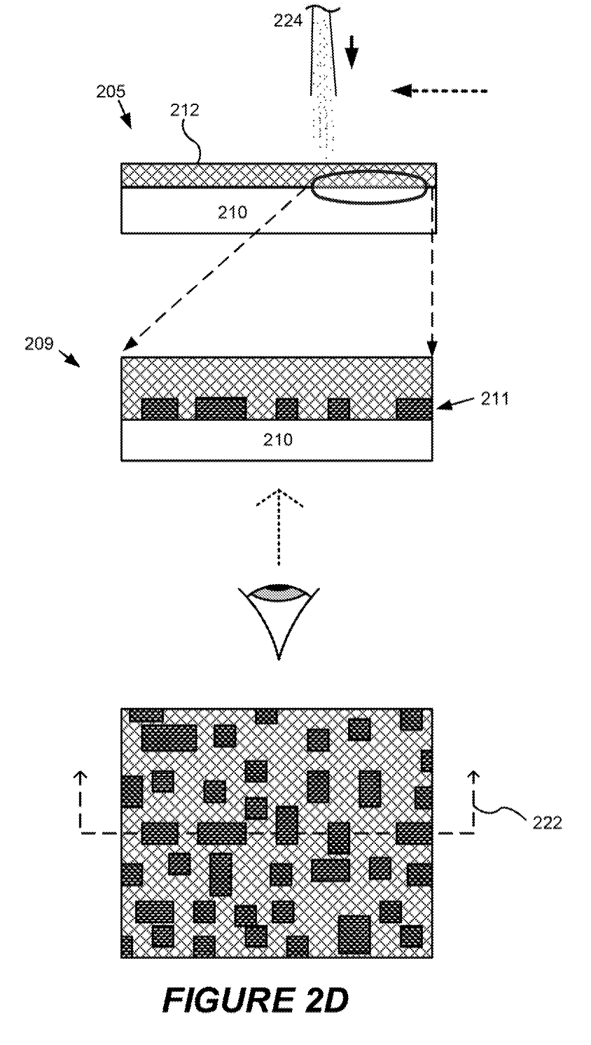

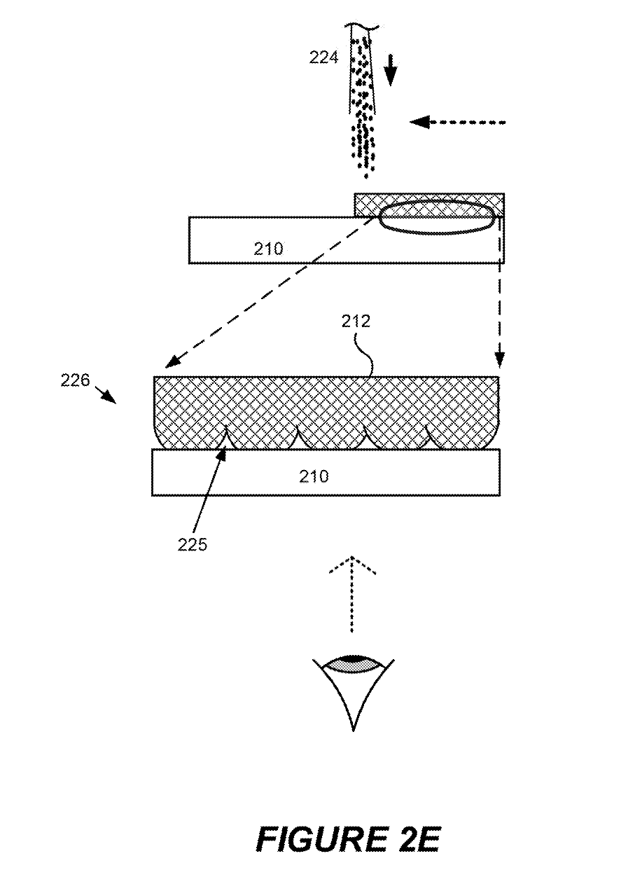

In certain embodiments, a second material that is opaque, substantially non-reflective, or otherwise not readily visible is added to the bus bar as depicted in FIGS. 2A-2D. In such designs, mixed materials may be less noticeable to occupants than if a single conductive material made up the visible portion of a bus bar. It should be noted that the size relations depicted of elements in FIGS. 2A-2D may not be representative of actual embodiments.

With reference to FIG. 2A, particles comprising a second material are deposited (e.g., accretively) on a transparent conducting layer 210 to form one or more patterns, shapes, lines, etc. to create a specular reflection obscuring effect. The second material 211 is deposited to leave some amount of void space 221 for the conducting material to make electrical contact with the TCL 210. The obscuring material covers some percentage of the TCL surface covered by the bus bar; for example between about 20% and 80%. After the second material 211 is deposited, the conducting material is accretively deposited such that interstitial spaces are filled in as depicted in 202. In some cases, the thickness of the conducting layer may be deposited such that it overcoats the second material as depicted in 203. The perspective of an observer looking through the electrochromic device (as depicted by the stylized eye) is shown in view 204. View 201 is a perpendicular cross-section of the EC device along the cut marked 222 after the second material has been deposited. Views 202 and 203 are perpendicular cross sections of the EC device along the cut marked 222 after the conducting material has been deposited.

In a similar embodiment depicted in FIG. 2B, particles comprising a second material are deposited (e.g., accretively) on a transparent conducting layer 210 in a randomized fashion to partially coat the surface of the TCL. The second material 211 is deposited to leave some amount of void space 221 for the conducting material to make electrical contact with the transparent conducting layer 210. The second material covers some percentage of the surface of the TCL; for example between about 20% and 80%. After the second material 211 is deposited, the conducting material is accretively deposited so that the void interstitial spaces are filled as shown in view 202. In some cases, the thickness of the conducting material may be such that it overcoats the second material as depicted in view 203. The perspective of an observer looking through the electrochromic device (as depicted by the stylized eye) is shown in 204. View 201 is a perpendicular cross-section of the EC device along the cut marked 222 after the second material has been deposited. Views 202 and 203 are perpendicular cross sections of the EC device along the cut marked 222 after the conducting material has been deposited.

In another embodiment, depicted in FIG. 2C, the conductive material 212 is deposited directly onto the TCL. This first deposition does not entirely coat the surface of the substrate, and it leaves interstices or void areas 223 for the second material to come into contact with the TCL. For example, material 212 is deposited as a monolayer or submonolayer, having a single depth of the particles in which particles generally do not stack on top of one another. As such, the particles may not touch each other on all sides, or at least not completely cover the area onto which they are deposited. In one example, larger particles, e.g. 100 μm or larger particles may be deposited as a monolayer, which does not have complete coverage and/or coalescence of the particles. In these embodiments, the conductive material covers some percentage of the surface of the TCL; for example between about 20% and 80%. After the conductive material 211 is deposited, the second material 211 is deposited (e.g., accretively) such that some of the second material comes into contact with the TCL, thus contributing to the desired obscuring effect. In some embodiments, after depositing the second material (shown in 206), the conducting material is deposited a second time, overlaying the second material and improving the conductivity of the bus bar. The perspective of an observer looking through the electrochromic device (as depicted by the stylized eye) is shown in view 208. View 205 is a perpendicular cross-section of the EC device along the cut marked 222 after the second material has been deposited. Views 206 and 207 are perpendicular cross sections of the EC device along the cut marked 222 after the conducting material has been deposited.

With reference to FIG. 2D, in another embodiment, the conductive material 212 is accretively deposited on the TCL. This first deposition entirely coats the surface of the substrate sufficiently to meet the electrical requirements of the bus bar. After the first layer is deposited, particles of the second material are deposited (e.g., accretively) with sufficiently high velocity to penetrate and embed into the conducting layer. In this embodiment penetrating particles of the second material may be larger, denser, and/or traveling faster than particles that were used for the deposition of the conducting layer. The perspective of an observer looking through the electrochromic device (as depicted by the stylized eye) is shown in view 208. View 205 is a perpendicular cross-section of the EC device along the cut marked 222 after the conductive material has been deposited while the penetrating particles of the second material are being deposited. View 209 is an enlarged view of 205 depicting particles of the second material that have penetrated as far at the TCL.

With reference to FIG. 2E, in another embodiment conductive material 212 is accretively deposited in a manner that produces diffuse, rather than specular, reflection. This is done by depositing large particles that retain much of their shape after impact, leaving void spaces 225, and a rough or matte surface at the interface of the two layers producing a diffused reflection. An enlarged view of the interface between the conducting layer and the TCL is shown in 226. In one embodiment the particle diameter is between about 100 μm and 1000 μm, in another embodiment between about 100 μm and 500 μm, and in another embodiment about 200 μm and about 400 μm.

In yet another embodiment, two or more conducting materials having dissimilar optical properties are deposited on the TCL layer such that the individual materials maintain their unique optical properties when they adhere to the substrate. In this method it is possible to create a surface that is less reflective or at least has less specular reflection. As an example, copper and tungsten may be accretively deposited as a mixture. Because the copper and tungsten have different reflective properties and colors, the resulting bus bar will be less noticeable to the viewer, e.g. in a butt joint application.

III. Bonding External Wire to Bus bar—Lead Attach

An external wire transmits electrical power from the window controller to the bus bar to drive the transitions from tint to clear and clear to tint in the EC device. This wire must be electrically connected to the bus bar. The connection should not introduce significant resistance and should be mechanically robust, with good pull strength. The “wire end” described herein refers the end of the end of the external wire that is soldered, welded, crimped, or in some other way electrically fastened to the bus bar. Using the accretive deposition methods described in this disclosure, the wire may be effectively welded or soldered by depositing conductive material at the juncture of the bus bar and the wire end.

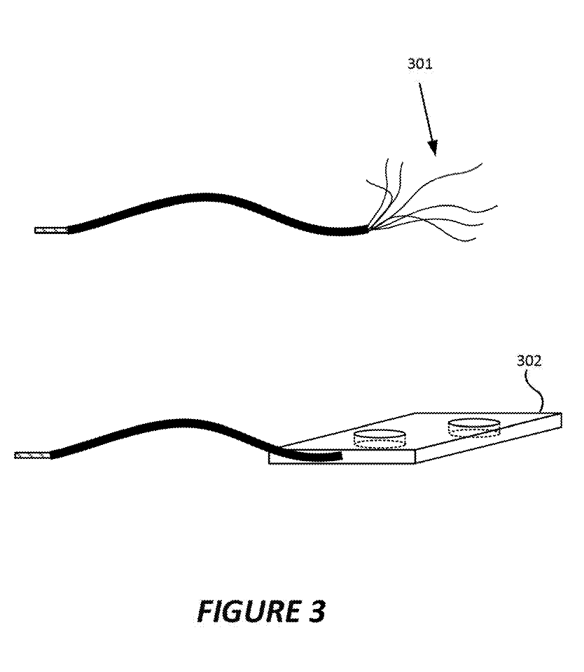

In some embodiments, the wire end maintains the same shape of the remainder of the wire (i.e., the portion of the wire extending away from the bus bar, back toward the window controller). In another embodiment, the wire may be flattened to increase the contact surface area as the wire end comes into contact with the bus bar. In some embodiments, the flattened end of the wire maintains the same cross-sectional area as the remainder of the wire. In yet another embodiment depicted in FIG. 3, a threaded wire may be splayed 301 at the wire end to increase the contact surface area for improved electrical and mechanical bonding to a bus bar. In some embodiments, the end of the wire, or splayed wire, may include surface roughening, perforations, or other texturing to facilitate strong bonding to the bus bar with accretive deposition.

With continued reference to FIG. 3, a fastener tab 302 at the wire end may be used to improve the reliability of an electrical contact to the bus bar. In certain embodiments, the fastener tab is between about 0.05 mm and 0.2 mm thick, or between about 0.05 mm and 0.15 mm thick. The thickness of the fastener tab may vary over the length of the tab. For example, the tab may be thicker where the wire end is attached, and it may taper to being thinner where the accretive deposited metal attaches the tab to the bus bar. As examples, the fastener tabs may be between about 2 mm and 10 mm wide and between about 5 mm and 25 mm long. While these dimensions describe a typical fastener tab, tabs are not bound by these size constraints. The tabs may be copper, tin, nickel, gold plated, silver plated, nickel plated steel, or other conductive materials. Wires are typically welded or soldered to the tabs, threaded through the holes in the tabs, crimped to the tabs, or are in some other method fixed to the tabs. Through accretive deposition, the fastener tab is then electrically connected to the TCL and/or bus bar via the accreted material soldering or welding the tab to the bus bar. In this example, the terms “soldering” or “welding” may not have the conventional meaning, as the bonding is due to accretion of metal particles and deformation to form a solid metal union between the bus bar and the wire or tab. The metal particles are not melted per se, though there may be melting at their interface with other particles, the wire or the tab during accretion due to heat formed via energy transfer during impact and deformation.

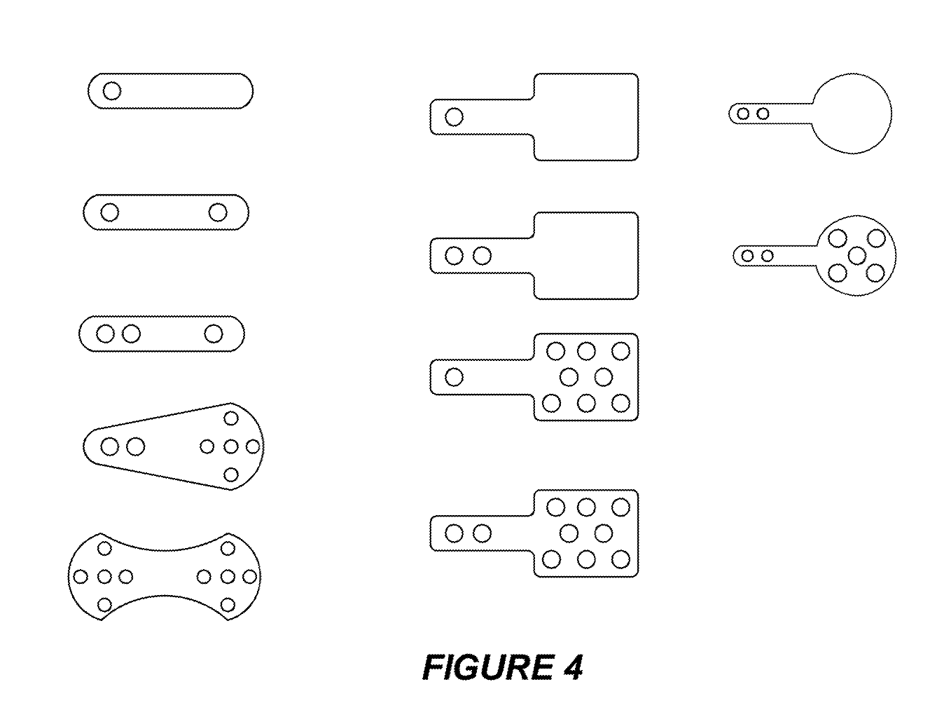

FIG. 4 depicts a top view of some shapes that may be used for fastener tabs. Apertures in the tabs may be for soldering wire to the tabs, welding the tab to the TCL, welding the tab to the bus bar, or welding the tab to both the TCL and the bus bar. Wires may be attached to either end of the tab shapes depicted and may require more surface area to be soldered or welded to the tab than is required to attach the tab the TCL, or vice versa. Wires may be attached in the middle of symmetric fastener tabs or wrapped around a fastener tab. Apertures may additionally have a bevel or taper to promote better particle entry and/or compaction in the accretive deposition.

Fastener tabs may be fabricated during electrochromic window processing, e.g. at an IGU or laminate assembly area. For example, tab machines can be fed with a roll of flat metal which is cut into the tab at the application point. Tape metal may further be perforated to minimize tooling that is needed for cutting tabs. Accretive deposition for crimping and soldering, or welding, can both happen on the surface of the TCL. In some embodiments, an accretive deposition machine may dispense a length of metal tape to contact the TCL or bus bar where accretive deposition welds the tab in place, and a machine cuts the tape and attaches a wire. Conversely, a machine might attach the wire end, cut the metal tape and the deliver the pre-wired tab to the TCL or bus bar surface where it is attached by accretive deposition.

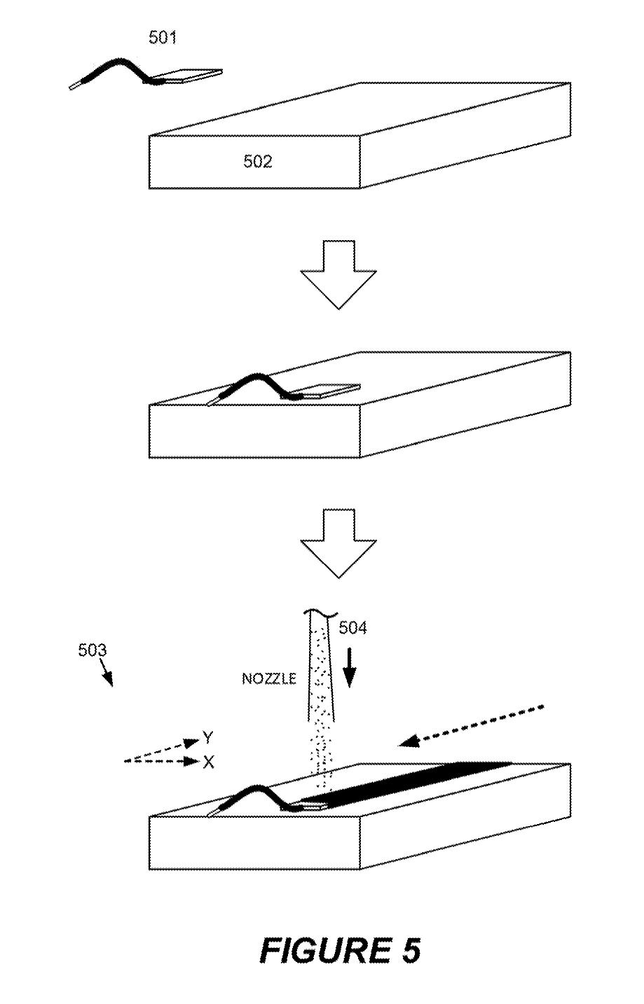

FIG. 5 (upper portion) depicts an embodiment where a wire end has been attached to a tab 501 prior to being brought into contact with the surface of a substrate 502. In the middle portion of FIG. 5, tab 501 is position on the surface to which tab 501 will be bonded. This surface may be a TCL, a partially fabricated bus bar, or another conducting layer. The surface may also be at the interface of a TCL layer and the underlying glass substrate. As shown in the lower portion of FIG. 5, the tab is then welded into place by accretively deposited particles 503. Contacting the tab to the substrate by cold spray deposition (or other accretive deposition method) may be done prior to, concurrently, or after the deposition of bus bars. In general, the accretive deposition in the region of the wire contact may have different dimensions and/or geometry than the accretive deposition in the remainder of the bus bar. For example, the accretion that forms the contact with tab 501 may be of a different width than that of the tab. For example, if the width of the accretively deposited material is less than the tab's width. The nozzle 504 and/or substrate 502 can be rotated or translated in the X-Y plane, and optionally translated in the Z direction to ensure coverage of the tab and/or weld strength. It should be understood that while the examples and associated description of FIG. 5 are made with reference to a tab wire end, other wire end structures may be employed in the same manner and for the same result.

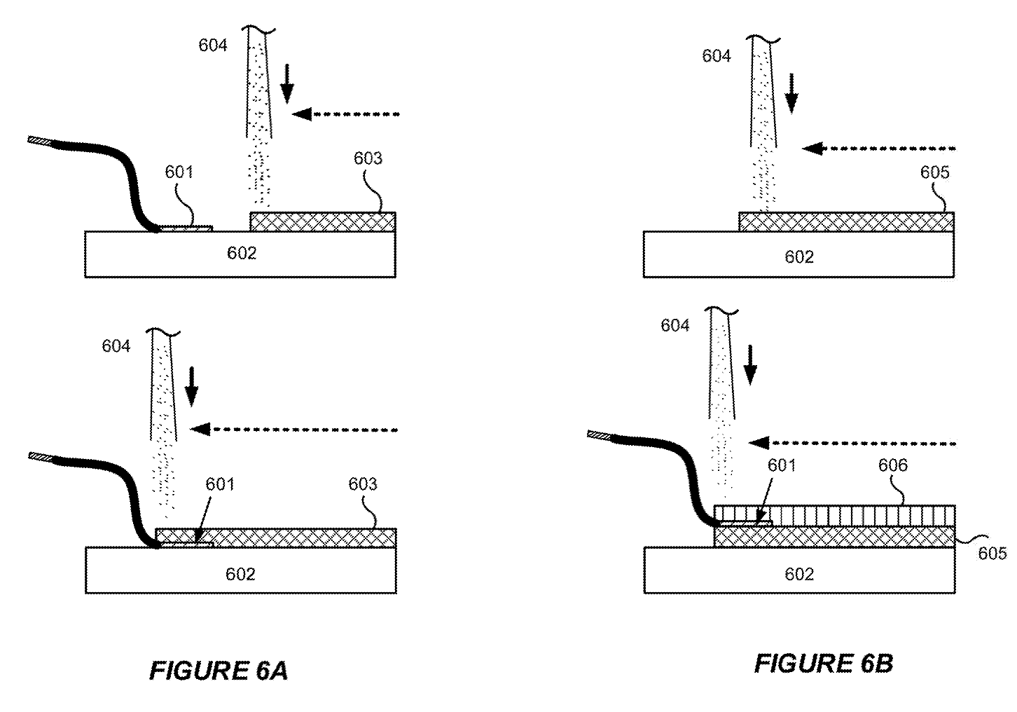

FIG. 6A depicts an embodiment in which a wire is attached directly to the surface of a transparent conducting layer of an electrochromic device. As a nozzle 604 of an accretive deposition apparatus moves in relation to a substrate 602 a bus bar 603 is deposited. See the upper panel of FIG. 6A. When the nozzle 604 reaches and overlies a tab 601, the tab is welded or soldered to the TCL forming an electrical connection that enables operating the electrochromic device.

In another embodiment, depicted in FIG. 6B, a first material 605 is placed on the substrate 602. In some embodiments, this material forms a bottom layer of a bus bar. See the upper panel of FIG. 6B. Next, a wire end 601 is placed on top of the first material at a location where the wire is to be connected to the bus bar. Then, a second material 606 is accretively deposited over some or all of the first material 605, thus encapsulating the wire end 601 between the first and second materials. The first material 605 and the second material 606 may have the same composition or may be of different compositions. In some embodiments, material 605 is an obscuring or masking material, as described previously, while material 606 is a conducting material that provides a highly electrically conductive surface for distributing applied potential to the TCL. In another scenario, the first material is selected for its adhesion properties to the TCL while the second material is selected for its electrical conductivity and/or ability to bond the wire end or tab. In yet another embodiment the first and/or second deposited layer may be a laminate containing two or more materials.

In certain embodiments, the bond joining the wire end to the bus bar has a pull strength of at least about 5 pounds (if that were pounds per square inch, it would be a much larger number); i.e., it takes about 5 pounds of force on the wire to cause the bond to fail. In certain embodiments, the bond has a pull strength of at least about 10 pounds.

### IV. Methods and Apparatus for Fabrication

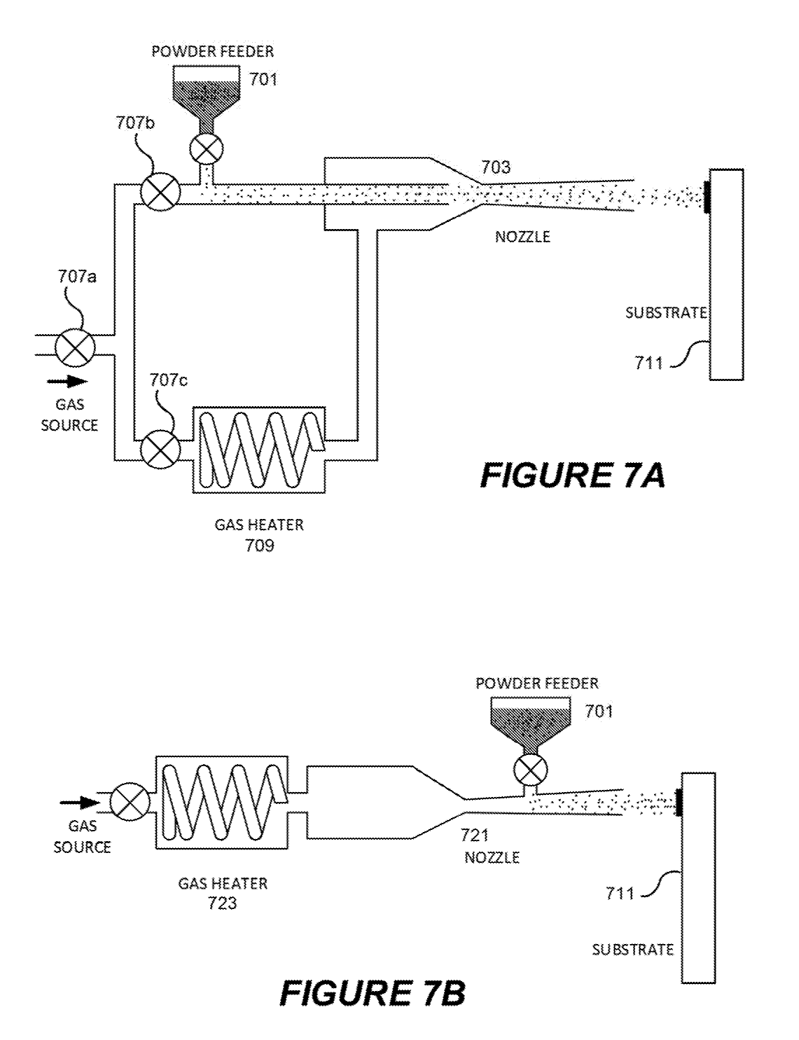

A high-pressure cold spray apparatus is depicted in FIG. 7A. In a high-pressure cold spray apparatus, a powder feeder 701 injects particles to be deposited upstream of a spray nozzle 703 such as a converging-diverging de Laval nozzle. In this apparatus, particles are driven by a flow of a carrier gas such as nitrogen or helium gas that is pressurized, e.g., to about 1000 psi. Valves 707a-c split the source gas line into two streams, the first of which is heated to about 1000° C. in a gas heater 709 while the second is used to carry particles from the power feeder 701 to the nozzle 703. Just before reaching the nozzle 703, the two gas streams are recombined. The gas-particle mixture then flows through the nozzle, and the expansion of the gas on the diverging side of the nozzle produces the conversion of enthalpy to kinetic energy, accelerating the gas flow to the supersonic regime (e.g., about 1000 m/s), while reducing its temperature. The accelerated particles impact a substrate 711 with sufficient kinetic energy to induce mechanical and/or metallurgical bonding.

FIG. 7B depicts an alternative cold spray apparatus. In this apparatus, a powder feeder 701 injects particles in the diverging section of a spray nozzle 721, e.g., a DeLaval nozzle, from a low-pressure gas supply. In this configuration, a source gas, typically air or nitrogen, is used that is pressurized at a relatively low pressure; for example between about 80 psi and about 140 psi. The pressurized gas is then fed through a gas heater 723 where it preheated before being fed through the nozzle 721. In some cases, the pressurized gas is heated to about 550° C. before being fed through the nozzle. On the diverging side of the nozzle, particles are released into the expanding and accelerating gas stream. Particles are accelerated by the gas stream and impact the substrate 711 with sufficient kinetic energy to induce mechanical and/or metallurgical bonding. Currently, there are many ready-to-used cold spray systems that are available in the marketplace, such as those being sold by CenterLine Windsor, Ltd.

The physical properties of a deposited material may be tuned by adjusting various deposition parameters. Variable parameters for the accretive deposition process include but are not limited to gas temperature, gas pressure, gas composition, particle size, powder feed rate, nozzle shape, and the distance between the nozzle and the substrate. There may be additional configurations of a high-pressure cold spray apparatus, such as ones containing more than one gas source, ones using different source gasses (argon or other inert gasses for example), and ones using mixtures of gasses. Further details regarding the operating mechanics of a high-pressure cold spray can be found in U.S. patent application Ser. No. 5,302,414, filed May 19, 1990, and incorporated herein by reference in its entirety.

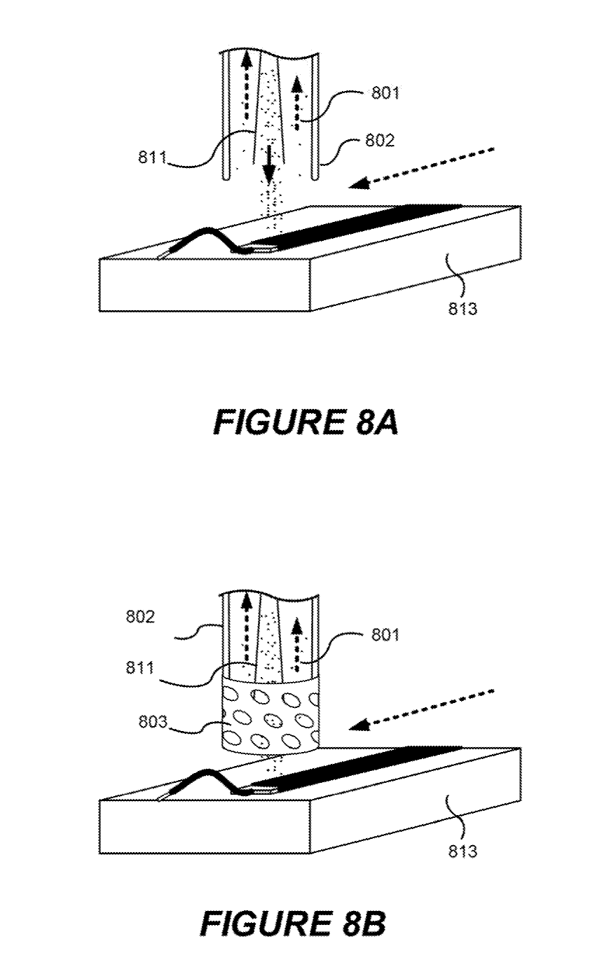

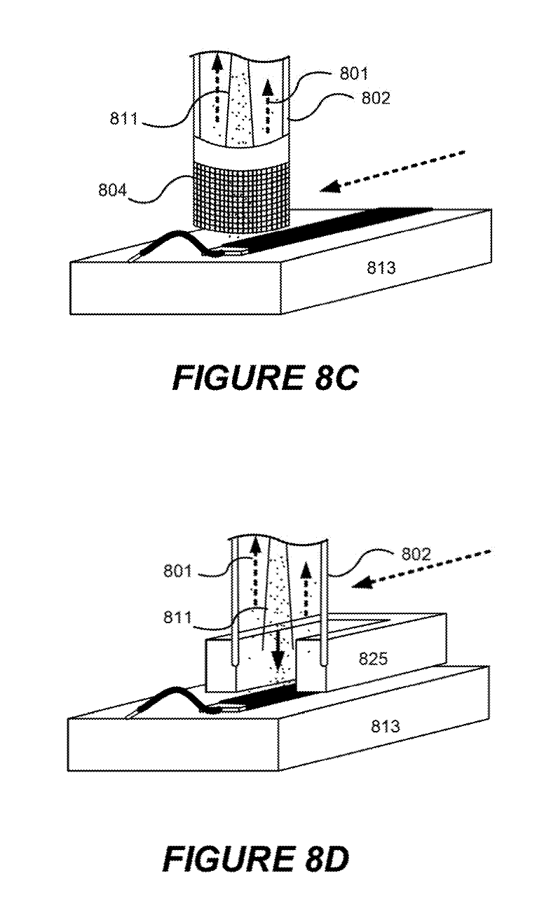

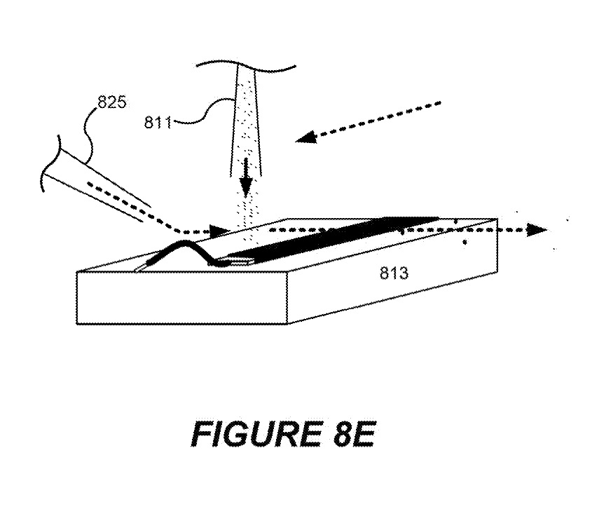

In some embodiments, a vacuum system is employed to remove particles that are not successfully deposited on the target substrate. FIGS. 8A-8D depict embodiments of a vacuum system that may be used to accretively deposit features 804 (e.g., bus bars) on a work surface 813. The vacuum systems, depicted by cut-away views in FIGS. 8A-8D, have vacuum area 801 around the nozzle 811 which may remove unused particles that are not successfully deposited on the substrate via a localized pressure differential. The vacuum area may be defined by a region that that is interior to an outer jacket 802. The tip of the outer jacket may come into contact with the work surface 813; for example, if the jacket is a Teflon material, is spring loaded, or has a soft brush head. The tip may also be configured come close to the work surface without touching it. How close the tip comes depends on the desired vacuum effect. By applying a vacuum near the deposition area, unused particles that are not successfully deposited may be removed, thus preventing contamination of the substrate and keeping deposited material local to the application site. While accretive deposition methods may achieve deposition efficiencies greater than 95%, it is desirable to remove any particles that are not successfully deposited on the substrate. While a powder may have a small distribution in particle sizes, there will inherently be a distribution of particle diameters within the powder. A deposition efficiency is the percent of particles having a smaller diameter than the largest particle diameter that achieves the critical velocity, minus the percent of particles having a smaller diameter than the smallest particle that can achieves the critical velocity, where the critical velocity is the velocity required to adhere to the substrate successfully.

FIG. 8B depicts an embodiment in which the outer jacket 802 includes a perforated end portion 803 that allows airflow inward through the perforations and into the co-axial vacuum area. The size, shape, and density of perforations may be tailored for the application. For example, these perforations may increase the velocity of the vacuum intake through the perforations and thus be more efficient at drawing particles away from the substrate.

FIG. 8C depicts another embodiment of an outer jacket 802 in which part of the jacket is mesh or screen structure 804. In certain situations, a fine mesh structure may be more effective at particle containment than a perforated structure due to the small openings of a mesh and the intake velocity at the openings is higher. In some cases, the mesh or screen may be made from a metal or polymeric material. In some cases, a mesh or screen structure may be rigid, and in some cases, a screen or mesh may be flexible. The screen or mesh, e.g. if flexible, may touch the substrate and drag along it as the bus bar is being deposited.

FIG. 8D depict an embodiment in which an apertured or channeled block 825 travels with the nozzle 811 to prevent particulate contamination of the bulk device. In some embodiments, the block 825 is made from a soft material such as polymer, e.g., polytetrafluoroethylene based polymer. The block 825 may maintain contact with the work surface or the block or be elevated slightly. In some embodiments, particularly those in which the block maintains contact with the substrate, the block is connected to the nozzle assembly by a spring loaded mechanism. Using an apertured or channeled block, a vacuum may be applied to either side of the accretion area by a suction tube, or a co-axial vacuum nozzle may be used. Additionally, a jet of an inert gas or nitrogen (not shown) may be used to blow particles and debris off the surface of the substrate and towards the vacuum source. For example, gas may be blown in a laminar regime across the work surface from one end of the channel to the other end of the channel where it is collected by a suction tube.

FIG. 8E depicts an embodiment of an accretive deposition system that uses an air knife 825 to blow undeposited particles off a substrate. The system has a nozzle 811 for ejecting particles onto the substrate and an air knife 825 that may be used to create a laminar flow across the substrate. The cold sprayed material is of sufficient velocity to penetrate the laminar flow and accretively deposit the bus bar material. Particles having insufficient velocity to penetrate the laminar flow, or those that penetrate the laminar flow but do not accrete are removed in the laminar flow, e.g. swept away from the electrochromic coating to avoid contamination of the coating. The accretive deposition machinery may, therefore, be in a room with air filtration to collect the unwanted particle stream.

While various cold spray apparatuses have been described, alternative fabrication methods may be used for this for accretive deposition. For example, high-velocity oxygen fuel spraying, and warm spraying may be employed.

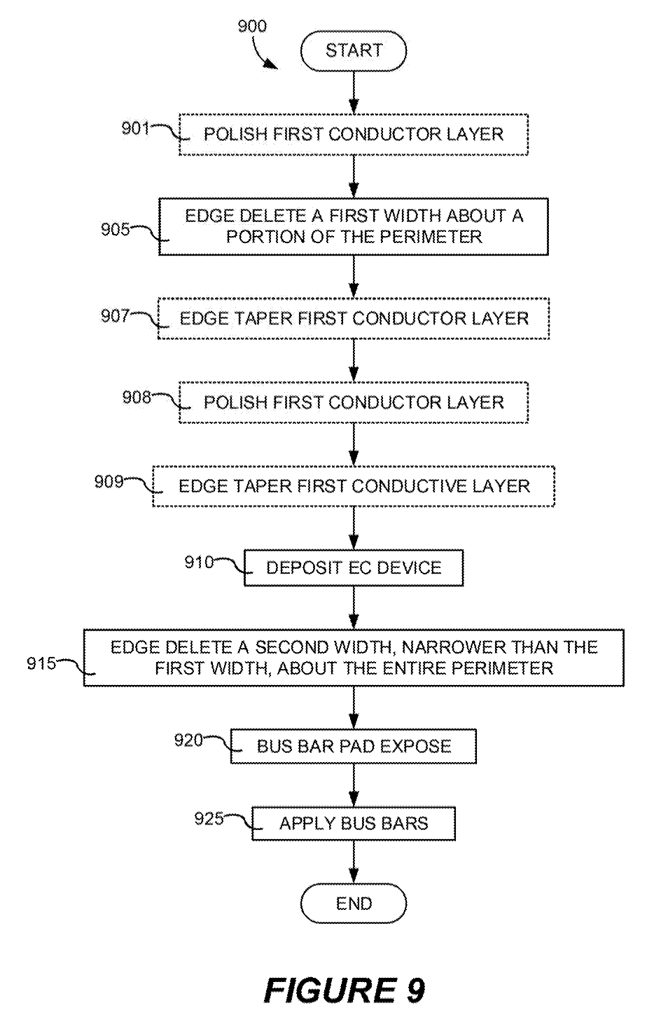

FIG. 9 depicts a process flow 900 of a method of fabricating an optical device (e.g., an electrochromic device) having opposing bus bars, each applied to one of the conductor layers of the optical device. The dotted lines denote optional steps in the process flow. After receiving a substrate with a first transparent conductor layer (TCL) thereon, the first transparent conductor layer may be polished 901. An edge of the first TCL is then deleted 905 by a first width about a portion of the perimeter of the substrate. The edge deletion may remove the first conductor layer and in some cases may also remove a diffusion barrier, if present. In some embodiments, at least a portion of the edge of the first transparent conductive layer are tapered, see steps 907 and 909. In some cases, tapering the first conductive layer may include a step of polishing first transparent conductor layer 908. The underlying diffusion barrier layer may also be tapered. Tapering the sharp edge of a first layer has been shown to reduce cracking of layers of subsequently deposited layers. Thus, tapering may be helpful in a similar manner to improve the adhesion of accretive bus bars and/or to inhibit damage from the impact of the accretive material. In step 910 an EC device is then deposited over the surface of the substrate. This deposition includes one or more material layers of the optical device and the second TCL. Process flow 900 continues with removing a second perimeter width, narrower than the first width, about substantially the entire perimeter of the substrate, see 915. A bus bar pad expose (or “BPE”) is then performed to remove a portion of the EC device layers in order to create a surface for a bus bar to be applied and make electrical contact with the electrode. In some cases, a BPE penetrates into the lower TCL. In some cases, a masking layer for the bus bars may then be deposited and patterned using lithography to protect the window surface although this is not the preferred method. Bus bars are accretively deposited 925 onto the device, one on the first TCL and one on the second TCL, see 925, 160(a) and 160(b) (see also FIG. 1). After completing process 900, bus bars now are electrically connected to the window controller, allowing for actuation of the electrochromic device.

While a primary application for the disclosed accretive deposition method is for fabricating bus bars, there are additional applications for electrochromic devices. For example, thin conductors may be fabricated around a glass substrate edge that may be used as part of a wiring network between the EC device and an on-glass controller or antenna on the surface of a substrate (e.g. the exterior surface of 120). In some cases, accretive deposition may be used to create an obscuration layer to hide or mask a bus bar.

V. Accretive Deposition using Plasma

While accretive deposition processes such as plasma-free “cold spraying” and “hot spraying” have been described, in alternative embodiments, accretive deposition may be performed using plasma. Plasma emitting from a nozzle imparts thermal energy to the feedstock powder, in some cases lowering the velocity necessitated for particles to bond to the target substrate. Some or all of the deposition apparatus features described above may be employed in plasma assisted embodiments.

In certain embodiments, a plasma assisted accretive deposition processes known as atmospheric plasma spraying (APS) is used. Deposition at or near atmospheric pressure eliminates or at least significantly reduces costs associated with vacuum deposition chambers that are typically required to create the low-pressure conditions needed for PVD and CVD. In some embodiments, APS may eliminate the need for ballistic (e.g. supersonic) depositions such as found in cold spray accretion. Plasma assisted depositions may use the same or similar metal powder feedstocks as cold spray, but use different methods to deposit the material. In some embodiments, accretion of bus bars using APS may be performed on temperature sensitive substrates.

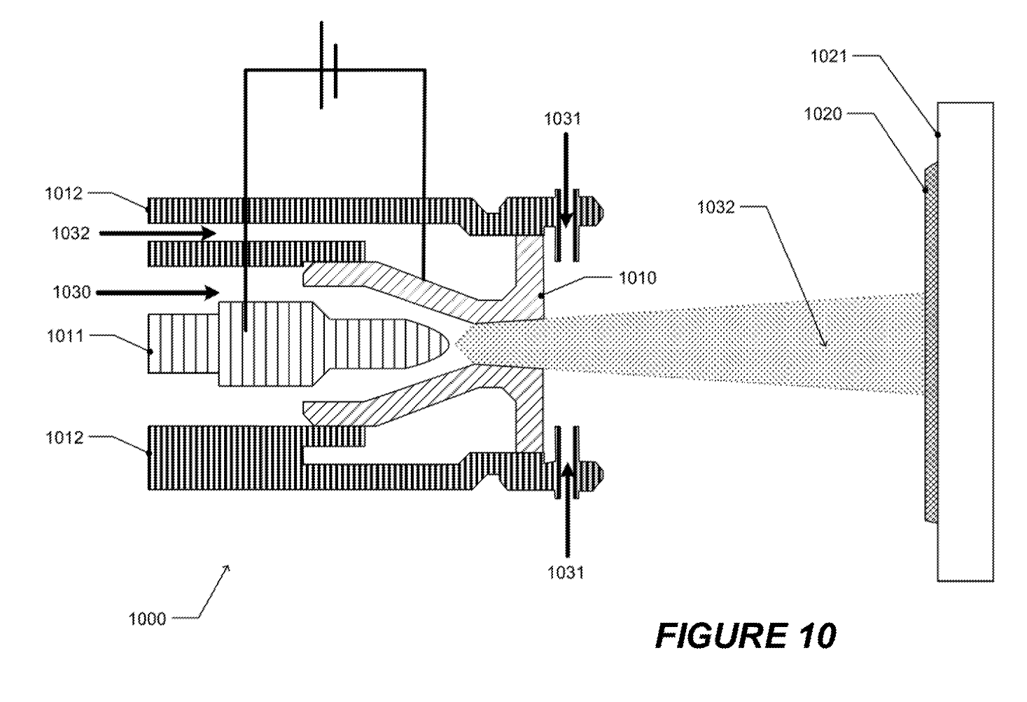

FIG. 10 depicts a cross-sectional view of an APS apparatus having a plasma gun 1000 for depositing a feature 1020 (e.g., a bus bar) on a substrate 1021. Within the plasma gun are two concentric electrodes—a first a first electrode that forms the nozzle 1010 and a second electrode 1011 on the central axis of the nozzle. In general, electrode 1010 is configured as the anode and electrode 1011 is configured as the cathode. An electric field is generated between the two electrodes, stripping electrons from the molecules of gas 1030, referred to as the plasma gas. The gas is ionized by the electric field, and the electric field may aid in the propulsion of ions through the nozzle. Suitable plasma gasses include argon, hydrogen, helium, and nitrogen gas. In the depicted embodiment, feedstock powder is injected into the plasma jet exiting the nozzle using a carrier gas 1031 (e.g., nitrogen gas) into the spray stream 1032 that exits the nozzle of the plasma gun which may be directed towards substrate 1021. The composition of the carrier gas may be the same as, or different from, that of the plasma gas. In certain embodiments, the carrier gas is inert to the powder and the substrate (even at the temperature of the plasma). In general, the feedstock powder is injected downstream of the nozzle interior (e.g., where the plasma is generated) to reduce the likelihood of accretion within the nozzle. Due to the thermal energy imparted to the particles in the spray stream, the velocity of particles may be low in comparison to accretive methods that are primarily ballistic in nature. For example, in some cases particles may be accelerated to less than about 700 m/s, in some cases particles may be accelerated to less than about 500 m/s. In some embodiments, the particles may be accelerated to subsonic speeds, e.g. less than about 343 m/s. Thus, generally, but not necessarily, lower particle speeds may be employed with APS as the particles may possess additional energy (e.g. thermal energy). As shown in FIG. 10, the plasma gun may be cooled by water 1032 that is passed through pathways within the outer structure 1012 of the plasma gun.

As with non-plasma accretive deposition methods, the plasma gun as shown in FIG. 10 may be configured to an industrial plotter device allowing the APS plasma process to be used for large scale production. In some cases, a plasma gun may be rotated or translated in a plane that is parallel to the substrate (e.g., see the X-Y plane in FIG. 5), or in a direction that is perpendicular to the surface of the substrate (e.g., see the Z-direction in FIG. 5). In some cases, a target substrate may also be translated or rotated with respect to the plasma gun. In some cases, a plasma gun may be sufficiently small that multiple plasma guns may be operated simultaneously to provide concurrent APS depositions on one or more substrates. In some cases, an APS apparatus may have a footprint in a plane parallel to the substrate that is less than about 20 cm by 20 cm, and in some cases, the footprint of the is less than about 10 cm by 10 cm. In some cases, bus bars may be deposited on an electrochromic device using a deposition system such as the plasma plotter produced by INOCON Technologie GmbH.

In some cases, the plasma reaches a temperature greater than about 10,000° C., in some cases, the plasma reaches a temperature greater than about 15,000° C., and in some cases a temperature greater than about 20,000° C. The plasma temperature may depend on parameters including the distance between the nozzle of a spray gun and the target substrate, the relative motion of the spray gun and the target substrate, the target substrate material, the grain size of particles in the feedstock power, and the material being deposited. Due to the extreme temperatures of the plasma gas, a wide range of metals (e.g. copper) and ceramic materials may be deposited. Since deposition occurs as series of small, individual molten particles that cool and solidify instantaneously upon impact, there is no heat-affected zone, or in some cases only a minimally heat-affected zone between the deposited coating and the substrate material. In some cases, such as when low-temperature plasma is used or the particle velocity is subsonic, target substrates that are sensitive to high temperatures may be compatible with APS depositions. For example, using a similar APS process, companies (e.g., INOCON Technologie GmbH) have demonstrated that metals may be deposited to form conductive features on fragile substrates such as cardstock paper with high adhesion and without damage to the paper.

In some embodiments, the substrate may be heated during accretive deposition of bus bars. In one example, the substrate is heated to between about 40° C. and about 200° C., in another example, the substrate is heated to between about 60° C. and about 150° C., and in yet another example the substrate is heated to between about 100° C. and about 125° C. In some cases, a substrate may be heated to facilitate accretion and/or adhesion of the bus bar to the substrate.

APS may be conducted with high powder feed and coating rates which further reduces the heat that is transferred to the target substrate. Using APS, coatings may be deposited to a thickness less than about 100 μm, less than about 50 μm, or less than about 10 μm. In some cases, APS coatings may be used to deposit a thickness of less than about 1 μm, and in some cases a thickness on the order of nanometers. Of course, thicker features may be created by, for example, increasing the powder feed rate, and reducing the speed at which as spray gun is moved across a substrate, and repeating the deposition process. In some embodiments, the bus bars are between about 1 mm and about 3 mm wide, in some embodiments, the bus bars may be deposited that are between about 1 mm and about 2 mm wide. In one embodiment, a bus bar is about 2 mm wide and between about 1 μm and about 100 μm thick, or between about 10 μm and about 100 μm thick, or between about 10 μm and about 50 μm thick.

In some cases, the surface of the target substrate may be treated or activated using “microplasma” before depositing material using APS. In some cases, such as when weakly ionized oxygen plasma is applied to a substrate, the adhesiveness of the substrate may be improved by removing weak boundary layers, cross-linking surface molecules, and/or generating polar groups of polymer material. While plasma in an APS apparatus is used to heat and propel particles so that they can be deposited, microplasma is used for treating or activating the target substrate and is applied directly to the surface of the target substrate. Due to the small dimensions of the microplasma, in some cases, it may be non-thermal, or substantially non-thermal in nature thus allowing microplasma applied directly to temperature sensitive substrates. In some cases, by improving the adhesiveness of a target substrate, the plasma temperature and/or the particle velocity process may be reduced when using APS deposition. In some cases, microplasma treatment of a substrate may be performed before other accretive deposition methods described herein. In some cases, microplasma is generated from a device depicted in FIG. 10. In some cases, a device for generating a microplasma may not require all the features of the depicted in FIG. 10, e.g., a microplasma device may not require cooling lines.

As with other accretive methods, bus bars and other features may be deposited in a laminate structure using APS. In some cases, before depositing a feature using APS, an APS apparatus such as that shown in FIG. 10 may first be used to deposit an adhesion-promoting coating that improves the interface between the deposited material and the target substrate. In some cases, a first deposited coating may protect the target substrate from a subsequent APS deposition that would otherwise damage the substrate. In some cases, an anti-adhesive coating is deposited on top of the deposited material, e.g. a bus bar. Anti-adhesion coatings may significantly reduce the surface tension of the substrate and improve the transmittance and scratch resistance of the target substrate. In some cases, anti-adhesion coatings may reduce the surface tension to a level that is comparable to that of polyfluoroolefins such as Teflon®.

1. A method of forming a bus bar for an electrochromic device, the method comprising:
(a) receiving a substrate with at least one transparent conductive layer of an electrochromic device disposed thereon; and
(b) accretively depositing a bus bar on at least a portion of the substrate or transparent conducting layer.

2. The method of claim 1, wherein accretively depositing the bus bar comprises depositing particles of a material comprising the bus bar by a mechanism that is primarily ballistic.

3. The method of claim 2, wherein depositing particles of the material comprises driving the particles from an accretive deposition apparatus containing a nozzle produces a gas jet that drives particles at high velocity towards the substrate.

4. The method of claim 3, wherein the particles leaving the nozzle have a mean particle velocity of between about 500 and 1500 m/s.

5. The method of claim 2, wherein the particles have an average diameter of between about 10 μm and 100 μm.

6. The method of claim 2, wherein the particles comprise copper, aluminum, and/or silver.

7. The method of claim 2, wherein depositing particles on the substrate comprises depositing a first set of first particles and a second set of second particles, wherein the particles of the first and second sets have different optical properties.

8. The method of claim 7, wherein the optical properties of the second particles at least partially mask or obscure visual perception of the bus bar.

9. The method of claim 7, wherein, the set of first particles are deposited to partially coat the at least a portion of the substrate or transparent conducting layer.

10. The method of claim 9, wherein the second particles comprise a metal or alloy, and wherein the second particles coat regions of the at least a portion of the substrate or transparent conducting layer that are not coated by the first particles.

11. The method of claim 7, wherein the first particles comprise tungsten and the second particles comprise copper.

12. The method of claim 1, wherein the electrochromic device is disposed between the transparent conducting layer and a second transparent conducting layer.

13. The method of claim 1, wherein the bus bar comprises a material having a resistivity of 10 uΩ/cm or less.

14. The method of claim 1, wherein accretively depositing the bus bar comprises depositing metal or alloy particles with only enough velocity to partially deform on the substrate or transparent conductive layer.

15. The method of claim 1, further comprising placing an external wire at a location of the bus bar and bonding an external wire to the bus bar, wherein bonding comprises the accretively depositing operation.

16. The method of claim 15, further comprising connecting the external wire to a window controller.

17. The method of claim 15, wherein the external wire comprises a flattened region, a tab, or a splayed region on the bus bar.

18. The method of claim 1, further comprising:
depositing a first layer at the location of the bus bar on the transparent conductive layer or the substrate;
placing an external wire on the first layer; and
depositing a second layer over the external wire, wherein depositing the second layer comprises the accretive deposition operation.

19. The method of claim 18, wherein the first layer comprises aluminum and the second layer comprises copper or silver.

20. The method of claim 1, wherein accretively depositing the bus bar comprises ejecting particles of the bus bar material through a DeLaval nozzle.

21. The method of claim 1, wherein accretively depositing the bus bar comprises cold spraying particles of the bus bar material.

22. The method of claim 1, further comprising applying a vacuum to remove particles that do not form the bus bar.

23. The method of claim 1, wherein accretively depositing the bus bar comprises exposing metal or alloy particles to a plasma before contacting the substrate or transparent conductive layer.

24. The method of claim 1, wherein before accretively depositing the bus bar, a microplasma is applied the substrate or transparent conductive layer.

25. An apparatus comprising:
an accretive deposition structure comprising a nozzle configured to accretively deposit particles to form a bus bar on a substrate with at least one transparent conductive layer of an electrochromic device disposed thereon.

26. The apparatus of claim 25, wherein the accretive deposition structure comprises a high-pressure or low-pressure cold spray apparatus.

27. The apparatus of claim 25, wherein the accretive deposition structure is a hot spray apparatus.

28. The apparatus of claim 25, wherein the accretive deposition structure has a deposition efficiency that is greater than 95%.

29. The apparatus of claim 25, further comprising a vacuum system configured to remove deposited particles.

30. The apparatus of claim 29, further comprising an outer jacket, concentric with the nozzle, wherein a region between the nozzle and the outer jacket is configured to provide a localized vacuum area.

31. The apparatus of claim 29, wherein the outer jacket contains perforations and/or a mesh to allow an inward flow of air.

32. The apparatus of claim 29, wherein the outer jacket is made from a Teflon material, is spring loaded, or has a brush tip.

33. The apparatus of claim 29, further comprising an apertured or channeled block configured to travel with the nozzle to prevent particulate contamination beyond the bus bar.

34. The apparatus of claim 29, further comprising a structure configured to provide a jet of gas to blow particles off the substrate and/or transparent conductive layer.

35. The apparatus of claim 25, wherein the accretive deposition structure comprises a plasma spray apparatus.

36. The apparatus of claim 35, wherein the plasma spray apparatus is configured to operate at atmospheric pressure.

37. The apparatus of claim 35, wherein the plasma spray apparatus comprises:
a first electrode that forms a nozzle through which plasma exits;
a second electrode positioned at an interior location to the first electrode; and
a voltage supply that is configured to apply an electric potential between the first electrode and the second electrode.

38. The apparatus of claim 37, wherein the plasma spray apparatus comprises a powder feedstock pathway configured to introduce the powder feedstock into plasma exiting the nozzle.

39. The apparatus of claim 38, further comprising a plotter that moves the plasma spray apparatus in the X-Y plane.

40. The apparatus of claim 38, wherein the apparatus is configured to deposit particles from the powder feedstock at subsonic velocities.
